(19) United States
(12) Patent Application Publication
(10) Pub. No.: US 2004/0201537 A1
(43) Pub. Date: Oct. 14, 2004

(54) Antenna having at least one dipole or an antenna element arrangement which is similar to a dipole

(76) Inventors: Manfred Stolle, Bad Aibling (DE); Andreas Scheyer, Tuntenhausen (DE)

Correspondence Address: NIXON & VANDERHYE, PC, 1100 N GLEBE ROAD, 8TH FLOOR, ARLINGTON, VA, 22201-4714, US

(21) Appl. No.: 10/441,265

(22) Filed: May 20, 2003

(30) Foreign Application Priority Data
Apr. 10, 2003 (DE) 103 16 564.9

(51) Int. Cl. H01Q 21/26

(52) U.S. Cl. 343/797

(57) ABSTRACT

An improved antenna having at least one dipole or an antenna element arrangement (11) which is similar to a dipole is distinguished in that the antenna element arrangement (11) is connected capacitively and/or electrically conductively without touching to the reflector (3) or to a reflector (3′) or a substrate (3′) which is non-conductive at least in the area in which the antenna element arrangement (11) is attached or mounted.

The invention relates to an antenna having at least one dipole or an antenna element arrangement which is similar to a dipole, according to the precharacterizing clause of claim 1

Dipole antenna elements have been disclosed, for example, in the prior publications DE 197 22 742 A and DE 196 27 015 A. The dipole antenna elements may in this case comprise a normal dipole structure or, for example, may comprise a cruciform dipole arrangement or a dipole square, etc. A so-called reflector cruciform dipole is disclosed in the prior publication WO 00/39894. The structure appears to be comparable with a dipole square. Owing to the specific configuration of the dipole antenna element according to this prior publication, however, this results in the end in a cruciform dipole structure such that the antenna element formed in this way can transmit and receive in two mutually perpendicular polarizations. All of these prior publications, as well as the other dipole structures which have been known to an average person skilled in the art for a long time, are to this extent also included in the content of the present application.

The object of the present invention is to provide an improved antenna having at least one dipole or an antenna element which is similar to a dipole, which has characteristic electrical characteristic values which are clearly reproducible in comparison to conventional antennas and which, if required, may in this case even be assembled more easily.

According to the invention, the object is achieved by the features which are specified in claim 1. Advantageous refinements of the invention are specified in the dependent claims.

While, until now, all generations of dipole antenna elements or of antenna elements which are similar to dipoles have been based on the idea of them being mounted on a reflector plate such that they are electrically conductively connected to it, the present invention is in contrast based on the idea of an antenna element such as this being capacitively coupled to the reflector plate. With the interposition of a non-conductive element, in particular a dielectric, this means that the antenna element can be positioned in a clearly reproducible manner from the electrical point of view, on the reflector plate, since the inter-modulation problems which occur in some circumstances according to the prior art are avoided. This is because, when a dipole or antenna elements which are similar to dipoles is or are mechanically mounted on the reflector plate according to the prior art, it or they have until now normally been fitted on the reflector plate by means of screws or other connecting mechanisms, thus resulting in different contact relationships depending on the assembly accuracy, with the consequence that intermodulation problems could occur, and express themselves in different ways.

In this case, it is also necessary to remember that, in the majority of all situations, the dipoles or antenna elements which are similar to dipoles are fitted on the reflector plate and are attached from the rear face of the reflector by screwing in one or more screws. However, if the contact pressure also decreases, for example as a result of thermal influences, then the contact relationships change, thus significantly detracting from the performance of an antenna element such as this.

A dipole or an antenna element which is similar to a dipole is thus preferably mounted, together with the dipole halves which actually transmit and receive and with its or their balancing device which is preferably integrally connected to it, on an electrically non-conductive cap, which is in turn fixed on the reflector plate.

However, a modified form is also possible, in which a dipole or antenna element which is similar to a dipole and which in either case is electrically conductive overall is used, including an electrically conductive attachment cap, but in which case, in order to avoid any conductive contact with the reflector, no insulating intermediate cap or non-conductive intermediate layer is used and, instead of this, the dipole or the antenna element which is similar to a dipole is, for example, coated or provided, at least in the area of its attachment section located at the bottom, with a plastic layer, that is to say in general an electrically non-conductive surface.

It is thus evident from the above statements that there is no conductive contact between the dipole or the dipole arrangement and the reflector, but that a capacitive coupling is produced by the preferably insulated mounting process. This also results in the advantage that no potential difference can occur between the dipole and the reflector. This is because the differently chosen materials for a dipole antenna element or the balancing device for a dipole antenna element and the material of the reflector mean that an electrochemical voltage is otherwise normally formed, which can lead to contact corrosion. Since the invention avoids this, this also results in a greater possible range of choice for the materials to be used for the dipole and/or for the reflector.

Furthermore, according to the invention, it is also possible to use plastic dipoles which have only partial metallization, that is to say in particular with these plastic dipoles not being metallized in the area in which they make contact with and are connected to the reflector. The balancing device is in this case preferably regarded as being electrically conductive, as part of the dipole arrangement.

Finally, the principle according to the invention also results in the mechanical and electrical functions being separated. There is now no need for any high contact or surface pressures, since there is no longer any need for a permanent electrical contact connection all the time between the dipole and its balancing device on the reflector.

Finally, a dipole arrangement according to the invention may also be plugged directly onto a board mount so that no-additional plastic part is required in situations such as these. The feed could in this case be provided directly via the rear face of the board structure, on which the matching structure is provided.

The explained principle in this case applies to all types of dipoles, vertical dipoles, dipoles polarized in an X-shape (that is to say at angles of ±45° to the horizontal) for single-band antennas, dual-band antennas or for dipole structures, in particular square dipole structures, in which two or more antenna elements are arranged within one another and are intended for different frequency bands.

In one particularly preferred embodiment, a suitable stamped-out area is provided in the reflector plate, into which the attachment cap of the antenna element can, for example, be clipped or inserted, and can be rotated etc. to the final fixing position. In this case, locking and attachment elements can be used, for example those known in the form of so-called bayonet fittings, including all the modified forms associated with them.

The invention will be explained in more detail in the following text with reference to drawings, in which, in detail:

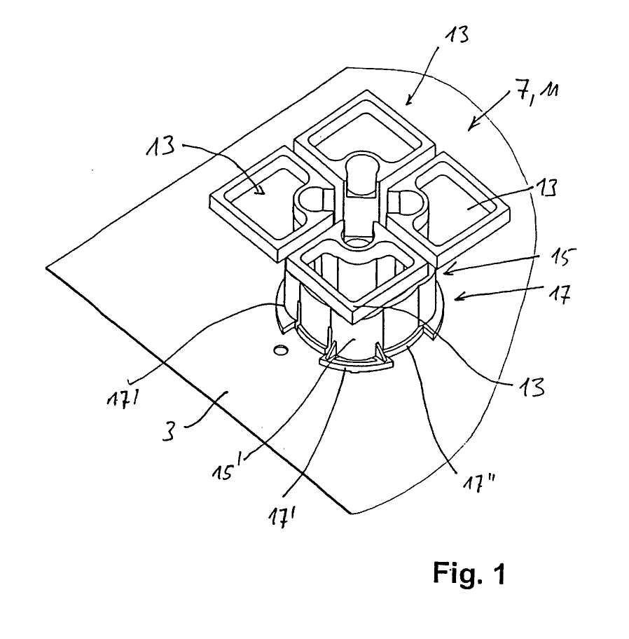

FIG. 1: shows a schematic perspective illustration of one exemplary embodiment of the invention, according to the invention;

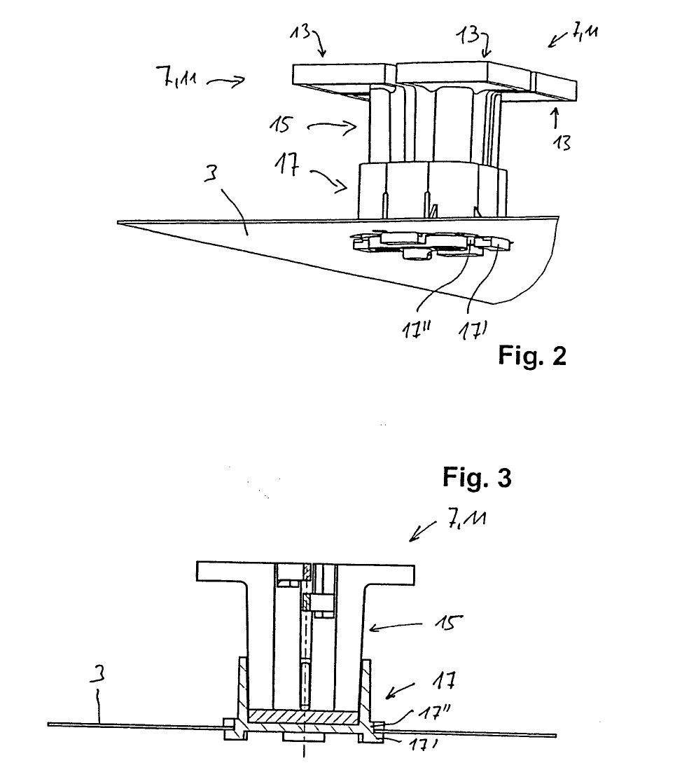

FIG. 2: shows a further perspective illustration of the antenna element arrangement shown in FIG. 1 on a reflector, but viewed slightly from the rear;

FIG. 3: shows a vertical cross-sectional illustration through the exemplary embodiment shown in FIGS. 1 and 2;

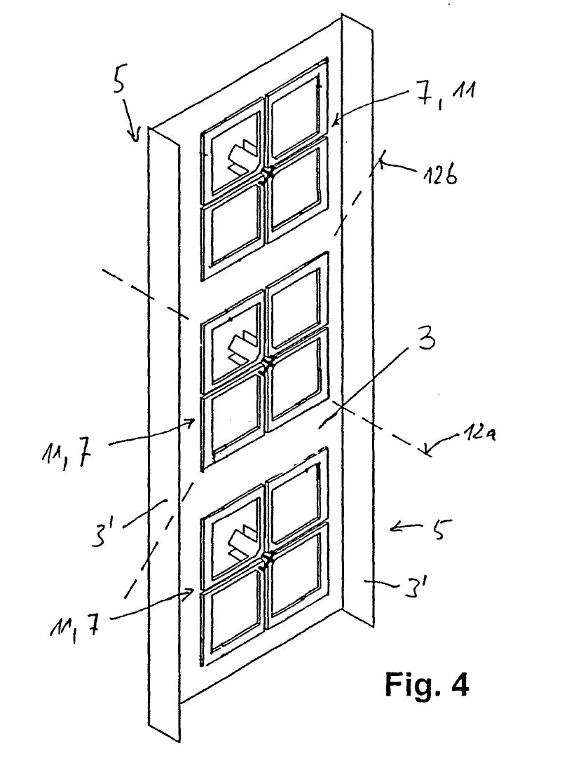

FIG. 4: shows a schematic perspective illustration of an antenna arrangement with three antenna elements arranged vertically one above the other; and

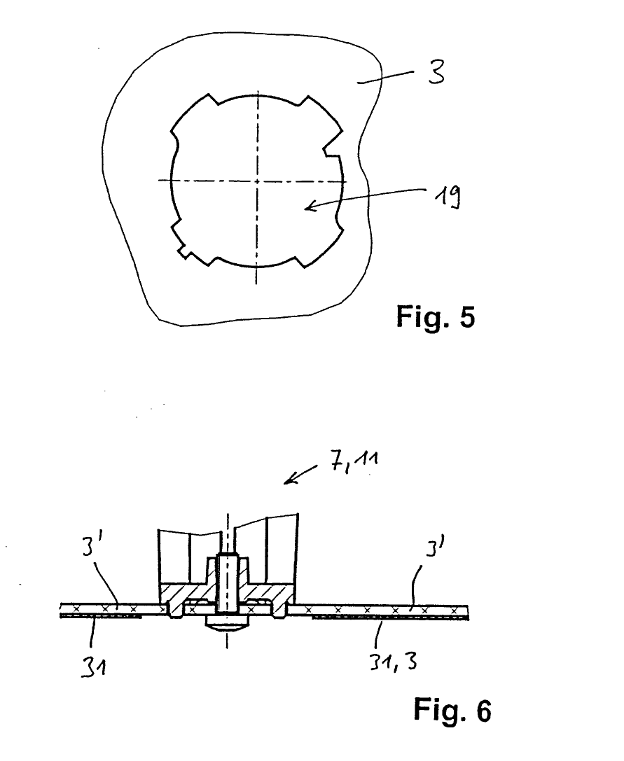

FIG. 5 shows a schematic plan view of a reflector with an opening incorporated there for fixing a cap of an antenna element arrangement as shown in FIGS. 1 to 4.

FIG. 6 shows an exemplary embodiment, modified from that shown in FIGS. 1 and 3.

FIG. 4 shows a schematic illustration of an antenna arrangement 1 with a reflector or reflector plate 3. The reflector 3 can be provided with a reflector boundary 3′, preferably on its two opposite longitudinal sides 5, which reflector boundary 3′ may, for example, be aligned at right angles to the plane of the reflector plate 3 or else at an obliquely running angle, which is not a right angle.

Two or more dipoles or antenna elements which are similar to dipoles are normally arranged offset in the vertical direction on one such reflector plate 3. The antenna element or the antenna element arrangements 7 may comprise single-band antenna elements, dual-band antenna elements, triple-band antenna elements or the like. With the modern generation of antennas, dual-band antenna elements or even triple-band antenna elements are preferably used, which can also transmit and/or receive in two mutually orthogonal polarizations and which in this case are preferably aligned at angles of ±45° to the horizontal or vertical. In this case, reference is made in particular to the prior publications DE 197 22 742 A and DE 196 27 015 A, which illustrate and describe different antenna with widely differing antenna element arrangements. All of these antenna elements as well as further modified forms may be used for the purposes of the present invention. It is thus also possible to use antenna elements with a real dipole structure, in the form of a cruciform dipole, a dipole square or in the form of a so-called vector dipole, as is known by way of example from WO 00/39894. All of these antenna element types and modified forms are included in the content of this application by reference to the prior publications cited above.

FIGS. 1 to 3 show a first antenna element arrangement 11 according to the invention, on a reflector 3 illustrated in different forms in relatively great detail. In this case, fundamentally, the antenna element arrangement 11 is of the same configuration as that which is known from WO 00/39894, and which is described in detail in this prior publication. Reference is therefore made to the full scope of the disclosure content of said publication, which is included in the content of this application. From this, it is known for the antenna element arrangement 11 as illustrated schematically in the form of a plan view in the exemplary embodiments in FIGS. 1 to 4 to be in the form of a dipole square, but to transmit and receive in the same way as a cruciform dipole, from the electrical point of view, by virtue of the specific configuration. FIG. 4 in this case shows the two polarization directions 12a and 12b for an antenna element arrangement 11, with these two polarization directions being at right angles to one another and being formed by the diagonal, by means of the antenna element arrangement 11 which effectively is in the form of a square when seen in a plan view.

The structures which are, in each case, inverted through 180° with respect to one another in the antenna element arrangement 11 to this extent act as dipole arms of two dipoles arranged in a cruciform shape.

An antenna element 11 in the form of a dipole formed in this way is held and mounted on the reflector 3 via the associated balancing device 15. The dipole halves 13 and the balancing device 15 are in this case composed of an electrically conductive material, generally metal or a metal alloy.

In order now to ensure capacitive coupling on the reflector plate 3, that is to say to provide an electrical connection without any physical contact, a cap 17 is provided which is composed of non-conductive material, for example a plastic, a dielectric, etc. The associated cap section 15′ of the balancing device 15 is fixed and held via this cap 17. The cap 17 is now in turn anchored in a recess 19 (FIG. 5) in the reflector plate 3. This may, for example, be done in such a way that the cap 17 has, in particular, radially protruding projections 17′, that is to say projections 17′ which protrude at the sides, as well as set-back sections 17″ so that this shape allows the cap to be inserted into a correspondingly shaped recess 19 in the reflector plate. After being inserted, the entire arrangement may, for example, be rotated through an angle of about 30° or 45°, until the final adjustment position is reached, which ensures that the cap 17 is held securely, preferably by means of a force fit, with respect to the recess 19, with the projections which protrude radially on the rear face or lower face of the reflector 3 engaging under the corresponding material sections of the reflector while, in contrast, other projections 17′ which are located at the top engage over parts of the reflector plate from above, that is to say in this way securely fixing the antenna element arrangement 11. If necessary, additional fixing means may be used, including interlocking fixing means, in order to ensure that the antenna element arrangement is held securely. Finally, screws can even additionally be screwed in through the plastic cap, for example also passing through the reflector plate in a further separate hole, but these are not electrically conductively connected to the antenna element arrangement of the balancing device.

Since the cap is composed of plastic the balancing device and the antenna element arrangement 11 overall are separated and isolated from the electrically conductive reflector or reflector plate 3 by means of the cap, this results in capacitive coupling.

As an alternative to the explained exemplary embodiment, a board structure 3′ or some other substrate 3′ can also be provided instead of the reflector plate 3, provided that it is non-conductive or is non-conductive at least in the anchoring area of the cap or of the antenna element. This is shown in a schematic cross-sectional illustration, in the form of an extract, in FIG. 6. Conductive structures on the lower face of the board, particularly large-area conductive structures 31 on the board in order to produce a reflector or metallization similar to a reflector, can be provided on the upper face or on the lower face of the substrate or of the board 3′, but in this case should not extend as far as the attachment area of the balancing device of an antenna element 7 or of an antenna element arrangement 11. There is therefore no need for any electrically non-conductive cap in this situation. The antenna element with its antenna element structure can be fitted and anchored directly on the non-conductive substrate or on the non-conductive board structure. The substrate can, in this case, preferably be formed from a board on whose rear face the electrically conductive matching structures are formed, without this resulting in any conductive coupling to the balancing device.

A modified form is likewise possible in which the entire antenna element including the balancing device is likewise once again composed of an electrically conductive material, with the cap section 15′ of the antenna element arrangement in this exemplary embodiment being coated with an electrically non-conductive material, plastic or a dielectric, and being fixed to the reflector plate via this coating. This also ensures a capacitive link to the reflector plate, that is to say an electrically non-conductive link with no physical contact.

Conversely, however, the antenna element arrangement or at least the balancing device overall, or essential parts of it, may be formed from non-conductive material which is then coated with a conductive structure, in particular a metallizing layer. Only those anchoring sections by means of which the antenna element 11 which is formed in this way is, for example, mounted on a conductive reflector 3 are excluded from this metallically conductive surface structure, in order to avoid an electrically conductive connection.

1. Antenna having at least one dipole or an antenna element arrangement which is similar to a dipole, characterized in that the antenna element arrangement is connected capacitively and/or electrically conductively without touching to the reflector or to a reflector or a substrate which is non-conductive at least in the area in which the antenna element arrangement is attached or mounted.

2. Antenna according to claim 1, characterized in that the antenna element arrangement has a balancing device whose cap section is connected to an electrically non-conductive cap with the cap being fixed on the electrically conductive reflector.

3. Antenna according to claim 1, characterized in that a recess is provided in the reflector, in which the cap engages and is anchored, at least partially passing through the recess.

4. Antenna according to claim 1, characterized in that the antenna element arrangement is electrically isolated from the reflector, with the interposition of an electrically non-conductive intermediate layer.

5. Antenna according to claim 1, characterized in that the antenna element arrangement is coated, at least in its cap section, with an electrically non-conductive layer, preferably a dielectric layer.

6. Antenna according to claim 1 characterized in that the reflector is provided with an electrically non-conductive surface layer at least on the face on which the antenna element arrangement is provided, and at least in the area of the attachment section of the antenna element arrangement to the reflector.

7. Antenna according to claim 1, characterized in that, at least in the area of its balancing device, the antenna element arrangement is composed of non-conductive material and is coated with an electrically conductive layer, with the exception of the attachment area on a preferably electrically conductive reflector.

8. Antenna according to claim 1, characterized in that the antenna element arrangement, including its balancing device, is electrically conductive, and the reflector or the substrate on which the antenna element arrangement and/or its balancing device are/is mounted is non-conductive at least in the mounting and supporting area.

9. Antenna according to claim 1, characterized in that the reflector or the substrate has a board structure, on whose rearward face, which faces away from the antenna element arrangement, a matching structure is preferably provided.

10. Antenna according to claim 1, characterized in that the cap is designed as a plug-in and/or rotary connection attachment device, which can be mechanically fixed to the reflector by insertion and rotation.
